(19) United States
(12) Patent Application Publication
(10) Pub. No.: US 2004/0030600 A1
(43) Pub. Date: Feb. 12, 2004

(54) System and method for producing a customer receipt including a marketing message

(76) Inventor: Blakely Lacroix, Lino Lakes, MN (US)

Correspondence Address: Attention of Mark T. Skoog, MERCHANT & GOULD P.C., P.O. B 2903, Minneapolis, MN, 55402-0903, US

(21) Appl. No.: 10/371,502

(22) Filed: Feb. 21, 2003

Related U.S. Application Data
(63) Continuation of application No. 09/289,246, filed on Apr. 9, 1999, now abandoned.

(51) Int. Cl. G06F 17/60

(52) U.S. Cl. 705/16

(57) ABSTRACT

The present invention relates to a system and method for modifying communication between an electronic cash register and an ECR printer. The system includes a message coupler adapted and configured to receive communication between the electronic cash register and the ECR printer, and to modify a data stream being communicated from the electronic cash register to the ECR printer. Modifying the data stream includes appending data to the data stream, inserting data into the data stream, substituting into the data stream, or a combination thereof. The system of the invention can be employed for printing a consumer specific marketing message on a customer receipt in response to a customer transaction. In this embodiment, the system includes an electronic cash register, the electronic cash register including an input peripheral for entry of a product code of an item of a customer transaction and an ECR printer. This embodiment also includes a message coupler, which is adapted and configured to receive communication between the electronic cash register and the ECR printer, and to provide to the ECR printer a consumer specific marketing message for printing on a customer receipt. In one embodiment, the method of the present invention is directed to printing a consumer specific marketing message on a customer receipt in response to a customer purchase. In this embodiment, the method includes preselecting one or more products, the purchase of which results in printing one or more consumer specific marketing messages; preselecting one or more marketing messages for printing in response to purchase of one or more preselected products; identifying a preselected product in a customer transaction; associating the identified product with the marketing message; and printing on the receipt one or more consumer specific marketing messages.

### BACKGROUND OF THE INVENTION

A customer receipt in a retail store printed from an electronic cash register or other point of sale terminal generally includes the name of the retailer, typically printed in block type, a list of items purchased and their prices, a total, the date of the purchase, and possibly credit card information. Although the receipt may include a header and/or a footer, they are fixed for all customers and the cost of customizing even the fixed header and/or footer is prohibitive. Certain point of sale terminals, for example, in grocery stores, include a second printer that prints one or more coupons in response to a customer's purchase or that prints a loyalty program message. Existing coupon printers are typically dependent on information from the network supporting the point of sale terminal and a processor that communicates with this network for determining whether to print a coupon and the identity of the coupon to be printed in response to a customer purchase.

Point of sale terminals including such a dedicated coupon printer suffer from numerous limitations. First, the system requires a second printer which prints the coupon on a second piece of paper separate from the receipt. This increases capital costs and, although a customer will nearly always look at a receipt, the customer can ignore the second piece of paper on which the coupon is printed. Second, such existing systems typically print coupons. The existing systems are not capable of printing a customized marketing message in response to a customer's purchase and on the receipt, where the customer is more likely to see it. Third, existing systems must monitor store controller communications for determining whether to print a coupon. Such existing systems will fail to recognize transactions with more modem electronic cash registers, which need not communicate with the store controller regarding sales of, for example, the 100 items in the store having the highest sales volume. Fourth, the existing systems are dedicated to the store controller and its hard wired network of electronic cash registers. Existing systems typically do not communicate during the transaction with another more advanced network or directly with systems external to the store network, such as the Internet. Fifth, existing systems require significant upgrades as the store controller is upgraded and may be incompatible with advances in network technology.

Many high volume retailers, such as grocers, operate on low margins and are adverse to large capital investments. A system that printed a marketing message on the receipt using the electronic cash register's receipt printer would provide a business advantage without additional capital expenditure or maintenance. In today's busy world, it is advantageous to target a message specifically at the consumer in a medium in which the consumer is very likely to receive the message. The application software in the store controller system is likely to be inadequate to fully tailor a message to a particular consumer and a message printed on a separate piece of paper can easily be ignored, especially when the message is limited to a cents-off coupon. All in all, existing systems are incapable of providing a varied, customized, and focused message in a medium that the customer is certain to see.

There remains a need for a system that, in response to a customer's purchase, prints a marketing message on the customer receipt and tailors that message to the particular consumer.

### SUMMARY OF THE INVENTION

The present invention relates to a system and method for printing a marketing message employing the printer of an electronic cash register (ECR) that prints the receipt, that prints the journal, and/or that prints on a slip, such as a charge card slip receipt (an ECR printer). The method and system of the invention can print a marketing message on a receipt in response to issuing a receipt. The system of the invention includes a message coupler that can provide a marketing message for printing by an ECR printer and/or on a customer receipt. Advantageously, the message coupler is adapted and configured for receiving communication between an electronic cash register and an ECR printer. The inventive message coupler can monitor information input into an electronic cash register through one of the ECR's input peripherals, such as a scanner, a keyboard, and the like. In response to appropriate input, the message coupler can substitute some or all of the input data stream, or append to or insert into the input data stream or a combination thereof. The substituted or appended data stream is then exported to a message coupler network and/or output to the ECR receipt printer as a marketing message. A marketing message printed in response to a customer's purchase is a consumer specific marketing message.

The message coupler advanageously includes sufficient processing and memory capacity to store at least one marketing message and to provide the marketing message to the ECR printer in response to a purchase of one or more preselected items. In addition, the message coupler can, as appropriate, provide a standard or seasonal message for printing on a receipt. In certain circumstances the message coupler can employ a message coupler network to communicate with a message coupler network controller for processing and memory capacity for storing one or more marketing messages and providing one or more of these messages to the ECR printer in response to the purchase of one or more items. The message coupler network controller can, when desired, access an external network, such as the internet for providing the marketing message. The message coupler network controller or external network can also be employed for storing and processing data regarding a customer transaction.

### BRIEF DESCRIPTION OF THE FIGURES

FIG. 1 illustrates a simplified block diagram showing a conventional store system with an in-store network of electronic cash registers with each of the peripheral devices interfaced separately to the ECR processor. A dotted line rectangle encloses those components present at a single check-out lane, and a dash-line rectangle encloses the components of the ECR. This conventional store system includes n electronic cash registers designated ECR, 1; ECR, 2; . . . ECR, n−1; ECR, n.

FIG. 2 illustrates a simplified block diagram of a conventional store system including a in-store network of electronic cash registers, with the peripheral connected to the ECR processor by a bus interface. A dotted line rectangle surrounds the equipment present at a single check-out lane, and a dash-line rectangle encloses the components of the electronic cash register. This conventional store system includes n electronic cash registers designated ECR, 1; ECR, 2; . . . ECR, n−1; ECR, n.

FIG. 3 illustrates a simplified block diagram of a message coupler and message coupler network according to the present invention incorporated into an in-store network of electronic cash registers. In this in-store network, each of the ECR peripherals are interfaced separately to the ECR processor. A dotted line rectangle encloses those components present at a single check-out lane, and a dash-line rectangle encloses the components of the ECR. This conventional store system includes n electronic cash registers designated ECR, 1; ECR, 2; . . . ECR, n−1; ECR, n.

FIG. 4 illustrates a simplified block diagram of the message coupler and message network of the present invention incorporated into an in-store network of electronic cash registers. In this figure the in-store system has ECR peripherals connected to the ECR processor by a bus interface. A dotted line rectangle encloses those components present at a single check-out lane, and a dash-line rectangle encloses the components of the ECR. This conventional store system includes n electronic cash registers designated ECR, 1; ECR, 2; . . . ECR, n−1; ECR, n.

FIG. 5 illustrates a prior art system for coupon printing employing a coupon printer network and dedicated coupon printers. In this illustration the ECR peripherals are separately interfaced to the ECR processor. A dotted line rectangle encloses those components present at a single check-out lane, and a dash-line rectangle encloses the components of the ECR. This conventional store system includes n electronic cash registers designated ECR, 1; ECR, 2; . . . ECR, n−1; ECR, n.

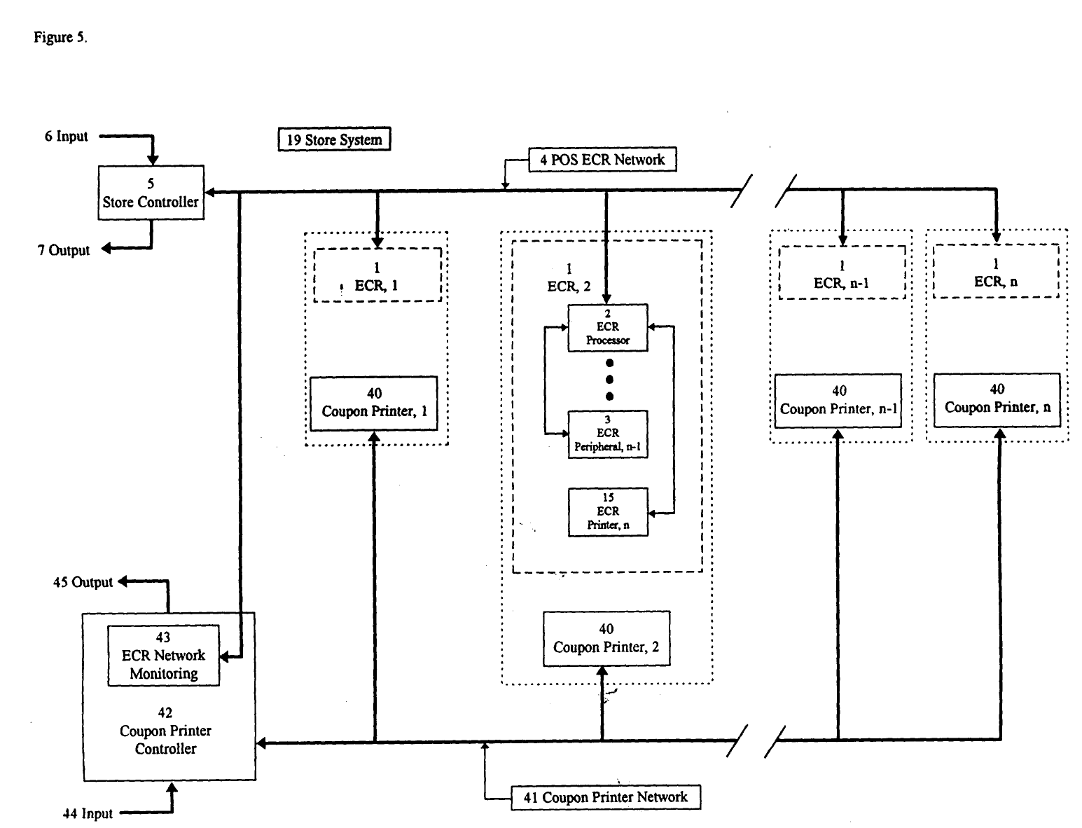

FIG. 6 illustrates a simplified block type diagram of another prior art system for printing coupons on dedicated coupon printers. In this system ECR peripherals are connected to the ECR processor by a bus interface. A dotted line rectangle encloses those components present at a single check-out lane, and a dash-line rectangle encloses the components of the ECR. This conventional store system includes n electronic cash registers designated ECR, 1; ECR, 2; . . . ECR, n−1; ECR, n.

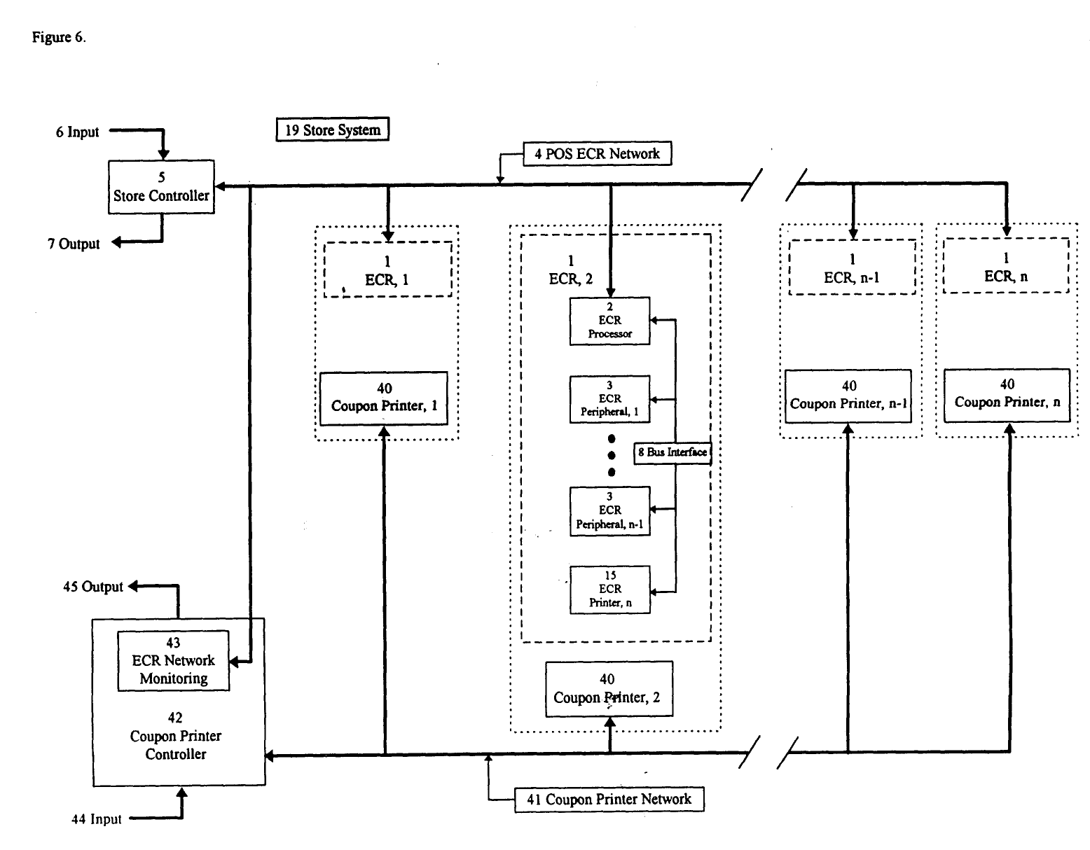

FIG. 7 illustrates a flow chart of in-lane processes for systems and methods of an embodiment of the present invention.

FIG. 8 illustrates a flowchart of the maintenance function of FIG. 7.

FIG. 9 illustrates a flowchart of the build local match table component of FIG. 8.

FIG. 10 illustrates a flowchart of the download new program component of FIG. 8.

FIG. 11 illustrates a flowchart of the input component found in FIG. 7.

FIG. 12 illustrates a flowchart of the export component found in FIG. 7.

FIG. 13 illustrates a flowchart of the data stream substitution component found in FIG. 7.

FIG. 14 illustrates the data stream insertion component found in FIG. 7.

FIG. 15 illustrates a flowchart of the output component found in FIG. 7.

FIG. 16 illustrates local area network processes for the message coupler network systems and processes of an embodiment of the present invention.

FIG. 17 illustrates a flowchart of the service lane request component found in FIG. 16.

FIG. 18 illustrates a flowchart of the service application requests component found in FIG. 16.

FIG. 19 illustrates a block diagram showing an application on the message coupler network retrieving a string from a message coupler and then returning a string to the message coupler.

FIG. 20 illustrates a block diagram showing an ECR printer including a receipt printer, a slip printer, and a journal printer.

FIG. 21 illustrates a conventional receipt and an enhanced receipt produced by an embodiment of the system and method of the present invention.

### DETAILED DESCRIPTION OF THE INVENTION

The present invention relates to a system and method for printing a marketing message employing the printer of an electronic cash register that prints the receipt, that prints the journal, or that prints on a slip, such as a charge card slip receipt (an ECR printer). Such a marketing message can be appropriate to the purchases reported on the receipt, to the season, or to a merchant's other marketing needs. The invention also relates to a system and method for monitoring a, preferably every, customer transaction entered into an electronic cash register by handling data exchanged between the cash register processor and the ECR printer. Although the system and method of the invention inject or transfer data from a line between an electronic cash register and the ECR printer, the electronic cash register sees only the ECR printer. The present system and method can modify a data stream sent to an ECR printer by an electronic cash register based on the content of that data stream. The modification can be locally stored or externally provided data. The modification can be in response to the content, the length or size, or other characteristics of the data stream.

The system of the invention includes what will be referred to herein as a message coupler. That is, the standard cable between the electronic cash register and the ECR printer is typically replaced by a message coupler including a cable and a processor assembly. The cable can be in one or more segments separated by, for example, the processor. The message coupler cable can accomplish all of the functions of the standard cable.

The processor assembly includes processing, memory, and communication hardware and firmware or software. The processor assembly can serve one or more of several functions. First, the processor assembly is transparent to the electronic cash register and an ECR printer that is standard with that electronic cash register, allowing substitution of an updated, for example, faster and more versatile, ECR printer. Second, the processor assembly can be adapted and configured for high speed data communication with protocol conversion and provide a mechanism for transfer of data from the electronic cash register to a network computer, for transferring data into the processor assembly to provide a response to a customer purchase, for sending a marketing message to the ECR printer for printing before, amid as part of, and/or after the list of items sold on the receipt, and/or for acquiring marketing data. This processor within the message coupler can, in response to a customer transaction or purchase, transmit a consumer specific marketing message, such as an advertisement, a loyalty promotion, a seasonal message, a coupon, a bar code, or the like, for printing on the customer receipt, on a slip, or on a journal.

Early electronic cash registers communicated with the store controller for data concerning every item purchased by a customer. As electronic cash registers have evolved with processors of increased power and with increased memory, they have become progressively more independent of communication with the store controller. For example, some current, advanced electronic cash registers store all of the information needed to conduct transactions for high volume items in the store. For transactions involving these items, the electronic cash register need conduct only communications with local peripheral devices without external or local area network (LAN) messaging. That is, the electronic cash register need communicate only with equipment at that checkout station or lane, which communication is referred to herein as intraregister communication. Typically, the advanced electronic cash register passes information regarding each of a customer's purchases to only one or a few peripheral devices that provide information to the customer, such as, the ECR printer or display. Therefore, a system that taps into communication of the electronic cash register with an external device advantageously taps into communication with the ECR printer or into the bus that communicates with the ECR printer to gain access to information concerning every item purchased by a consumer. The system of the present invention can receive communication with the ECR printer and/or communication on the bus that communicates with the ECR printer. The present system and method can also receive data from intraregister communications not directed to the printer, and employ this data for preparing a consumer specific marketing message.

Communication between the electronic cash register and its ECR printer then becomes a primary external communication that can be monitored and received for communicating complete marketing information to an outside system or to provide a response to the entirety of each customer purchase. Monitoring or receiving only communication with the store controller would miss transactions involving any items for which information is stored in the electronic cash register. The message coupler assembly of the invention thus can provide a mechanism for monitoring and/or receiving the entirety of each customer transaction, even with the most sophisticated and independent electronic cash registers.

The message coupler assembly of the present invention can communicate details of each customer transaction to a local area network that is independent of the store controller and the network that operates the electronic cash registers. This system can, during a particular customer transaction (e.g., in real time), transfer marketing data from that customer transaction to either an in-store or external database. This database can then, in response, transmit a consumer specific marketing message, such as an advertisement, a loyalty promotion, a seasonal message, a coupon, a bar code, or the like, for printing on the customer receipt.

This real time communication with a network or processor independent of the store controller provides a system for delivering a consumer specific marketing message that is both simpler and more powerful than a system which employs the store controller. For example, the store controller is in large part dedicated to controlling the electronic cash registers and associated databases. Any use of data or processing capacity of the store controller is constrained by the requirement that it be done in conformance to the protocols and capacities of the store controller. Further, any updates to the store controller, the network controlled by the store controller, or the electronic cash registers and their associated software and databases typically require that other software resident in and dependent upon the store controller and its databases be altered as well. A message coupler system that is independent of the store controller and employs an additional local area network depends only on the protocols for communication between the electronic cash register and the ECR printer. Changes in this protocol can be addressed more readily, more economically, and need be addressed less frequently than updates to the store controller.

The system and method of the present invention can print a consumer specific marketing message at one or more of several locations on the customer receipt. A consumer specific or other marketing message can print before the list of items purchased, as a part of, amid, and/or interrupting this list. Alternatively, a consumer specific marketing message can be added at the end of the receipt after the list of items purchased. For example, the system can print a store logo at the top of a receipt and consumer specific marketing message at the bottom of the receipt. Alternatively, the system can print a consumer specific message such as a loyalty promotion, an advertisement specific to one or more items purchased, a message tailored to the season (e.g., Christmas or Easter, summer or fall, the school year), or the like at the top of the receipt or interrupting the list of items purchased and a store logo or other message else where on the receipt. In addition, the system and method of the present invention can alter the order in which items are printed on the receipt, for example to consolidate like items or to alphabetize the receipt.

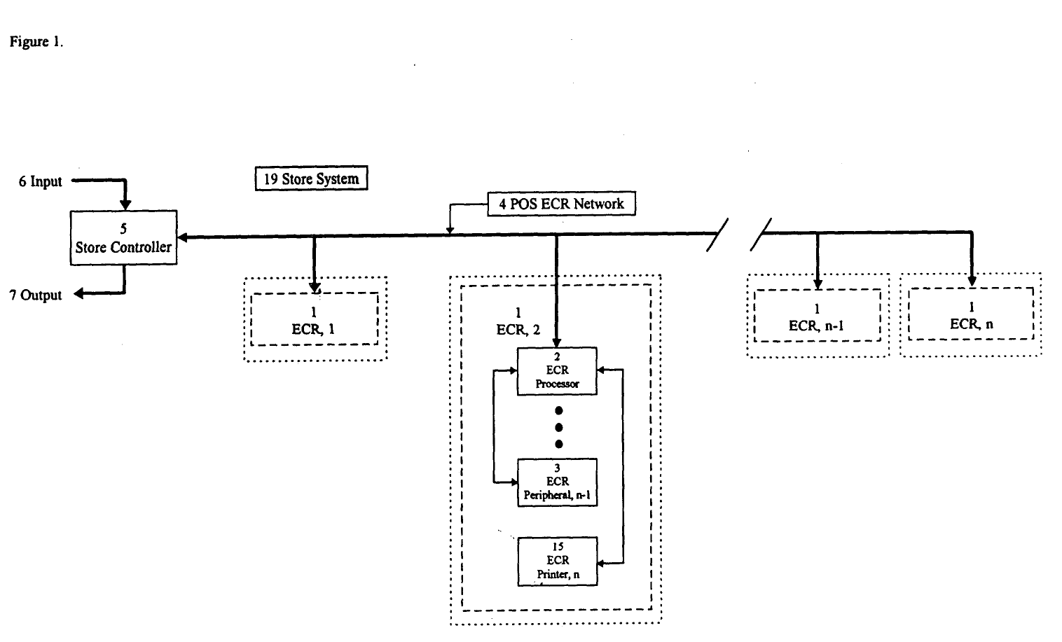

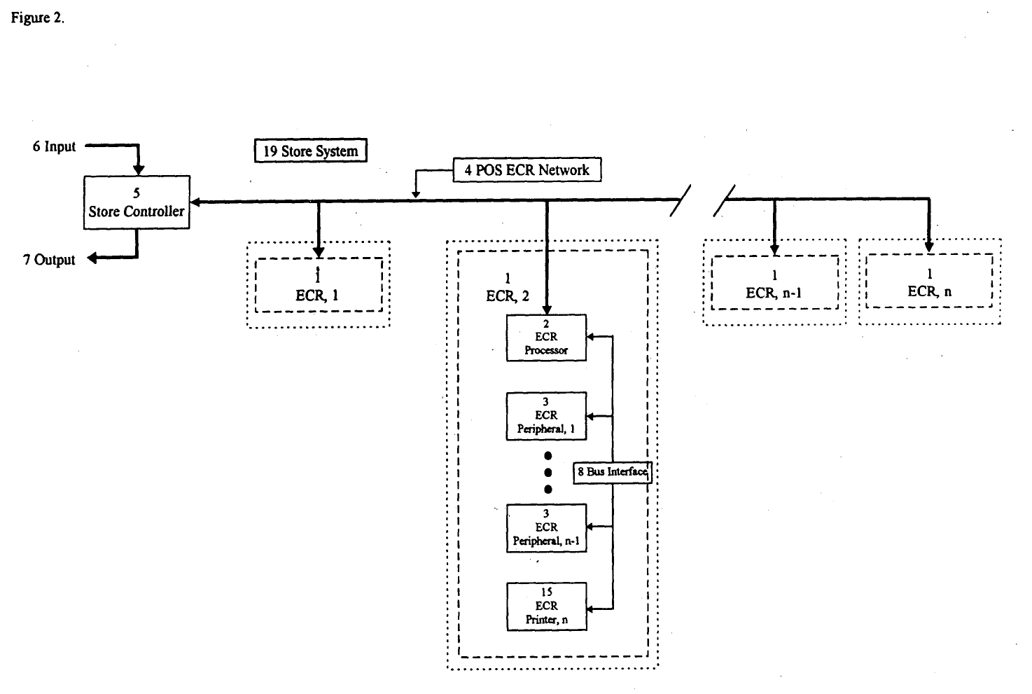

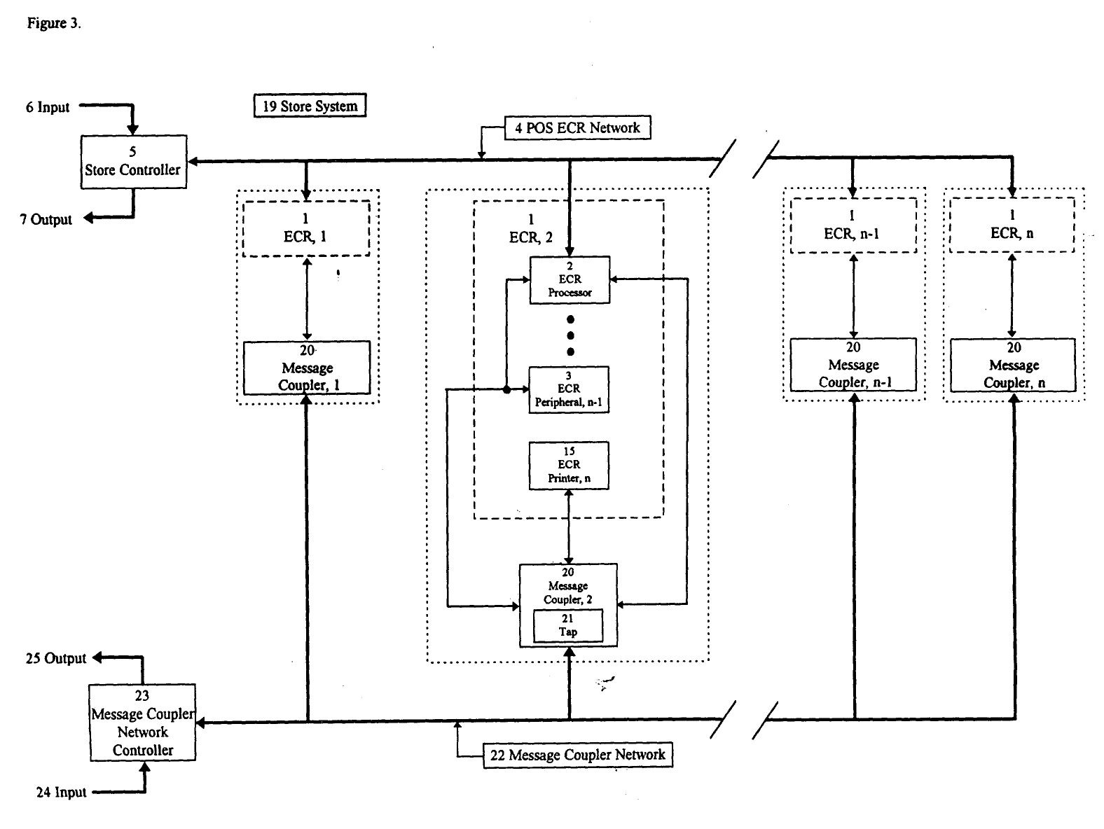

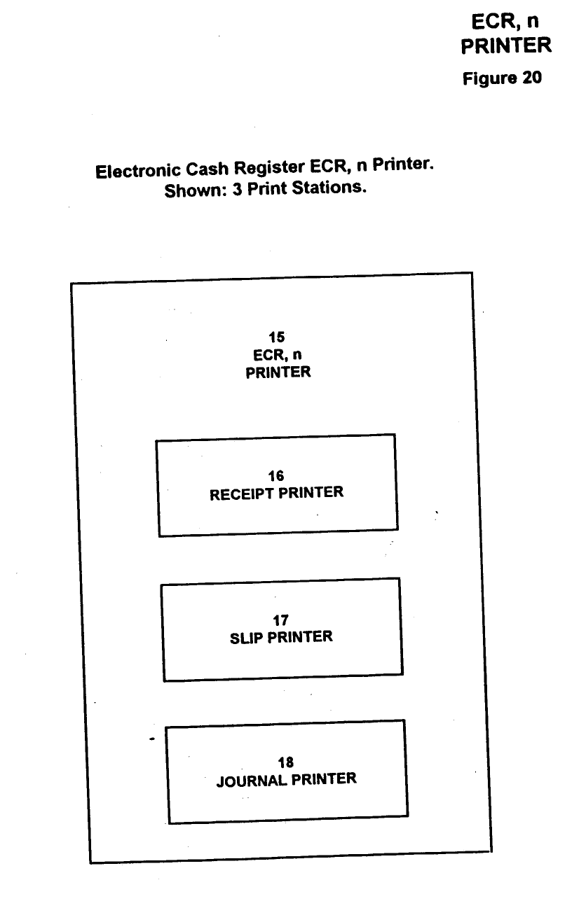

FIGS. 1 and 3 show simplified block diagrams of the components of a conventional store system 19. A series of from one to several (that is, up to “n”) electronic cash register(s) (ECRs) 1 are linked to store controller 5 by ECR network 4. ECR network 4 can be any of a variety of types of networks such as a conventional hardwired local area network, a wireless local area network, and the like. Electronic cash register 1 typically includes one or more ECR peripherals 3 such as an ECR processor 2 and one or more peripherals 3, for example, a display 7, a keyboard 11, and a scanner 13. Peripheral 3 can be interfaced with ECR processor 2 either individually (FIG. 1) or through a bus interface 8 (FIG. 2). ECR processor 2, with or without interaction with store controller 5, provides information regarding each product purchased and any other required details of the transaction to ECR printer 15. ECR printer 15 can be an integral component of electronic cash register 1 or it can be a separate stand alone unit. Each electronic cash register 1 typically has one ECR printer 15. A conventional ECR printer can print a receipt, a journal, and/or a slip, such as a charge card receipt. Typically, an ECR employs a single printer that can have one or more stations for printing a receipt, a journal tape, and/or a slip. These individual stations can be referred to as receipt printer 16, slip printer 17, and journal printer 18 (FIG. 20).

Store controller 5 and/or ECR processor 2 include conventional memory systems that store information regarding, preferably, each product in the store. An older conventional store system 19 includes, for example, numerous files in the store controller 5 or associated memory and contains a record for each product in the store. Alternatively, a master ECR (not shown) can store numerous files regarding products in the store, which is retrieved as required by each lane ECR 1. A more modern conventional store system 19 can include an ECR processor 9 having memory adequate to store files and records relating to, for example, up to about 100 or more of the products in the store that undergo the largest number of transactions. Store controller 5 can be coupled to another processor or other computers for receiving input and providing output by lines 6 and 7, respectively. Input 6 and output 7 lines can be any conventional communication link used for data transfer, such as a telephone line or hardwire link. Output from store controller 5 can be used for accounting and other purposes within the store or chain of stores either singly or in combination with data from several stores. Output from or input to store controller 5 can be part of a file or record of a database conventionally stored in a computer memory.

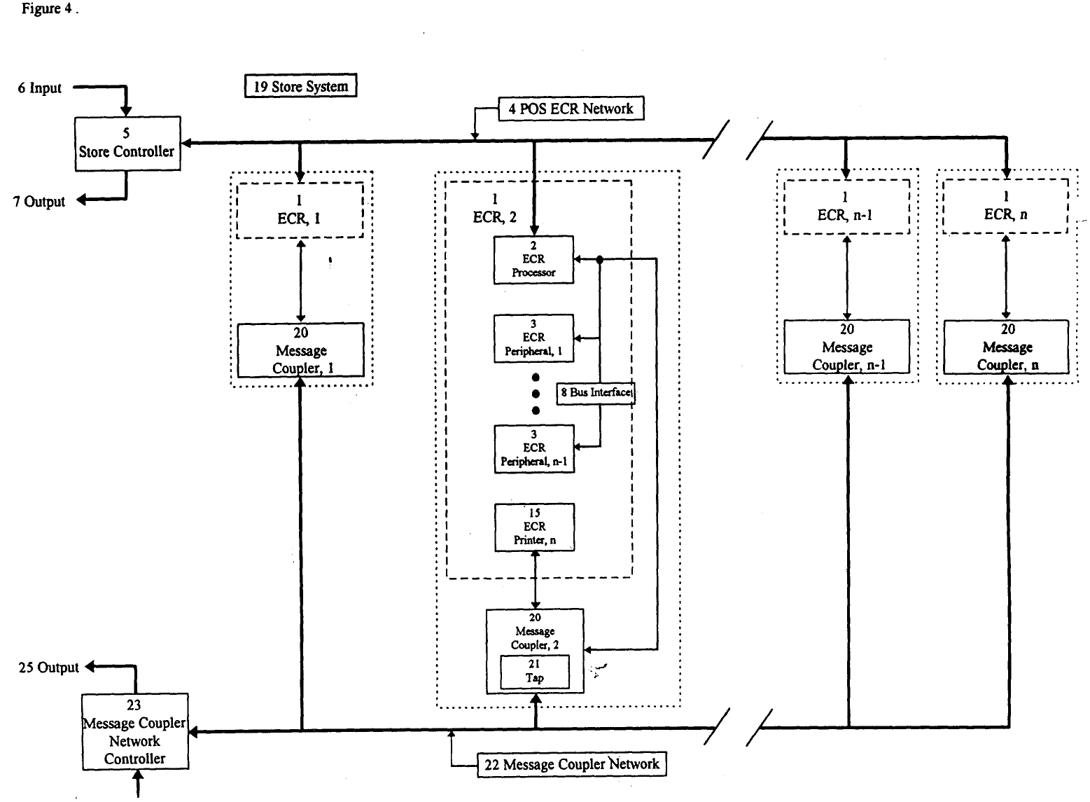

FIGS. 3 and 4 illustrate simplified block diagrams of embodiments of systems of the present invention. These Figures illustrate a message coupler 20 linking ECR processor 2 with ECR printer 15. Although the Figures illustrate one message coupler 20 per electronic cash register 1, a message coupler 20 can be constructed to work with two or more electronic cash registers 1. Message coupler 20 includes a tap 21, which is a processing unit that acts on information being transmitted from ECR processor 2 to ECR printer 15 and can, as appropriate, monitor other intraregister communications. Message coupler 20 can be capable of actions including communicating with ECR 1, communicating with ECR printer 15, communicating through message coupler network 27, receiving information from message coupler network 27, under appropriate circumstances, sending a consumer specific marketing message to ECR printer 15, and the like. Message coupler 20 can also include sufficient memory and other processing capacity to provide a standard message to each receipt, to provide at least one message to a receipt in response to at least one purchase, to provide printer interface, to control ECR printer 15, to carryout other conventional operations for data communication and printer control, and the like. Message coupler 20 can locally, that is employing its own memory and processing capacity, store and download messages, execute and download programs, and the like. As used herein, local programs and messages reside in message coupler 20. Preferably, message coupler 20 includes sufficient memory and other processing capacity to store a plurality of consumer specific marketing messages and/or to monitor and analyze multiple items purchased to provide a consumer specific marketing message in response to the purchase of one or more of these items.

Advantageously, message coupler 20 or tap 21 includes, or has access to, sufficient processing capability to analyze the content of a customer's purchase as communicated by tap 21 or message coupler 20, and to correlate an item or items purchased with one or more consumer specific marketing messages to be provided. For example, the printing on a receipt for a particular product can be highlighted, enlarged, supplemented and/or replaced with a slogan or graphic, supplemented with additional product information, or the like compared to the typical receipt printing for this product. Message coupler 20 then directs printing of the desired consumer specific marketing message or messages on ECR printer 15. Message coupler 20 can emulate a particular ECR printer expected by ECR processor 9, or provide the same informational interface or connectivity as that printer.

Message coupler network 22 can be linked to a plurality of electronic cash registers 1, message couplers 20, and ECR printers 15. Message coupler network 22 is not controlled by store controller 5, but is controlled by a message coupler network controller 23. Message coupler network controller 23 can be a computer in the store that serves other functions as well, can be a board in a computer (e.g. a personal or micro computer), can be a proprietary stand alone system dedicated to the message coupler network 22, or the like. Message coupler network controller 23 can provide access to the Internet, to other computers, and provide data exchange during a transaction, and/or in real time, by conventional methods known to those of skill in the art. Message coupler network controller 23 includes, or has access to, one or more databases including files and records, in conventional format, that contain the information needed for determining the consumer specific marketing message to be printed on the customer receipt. Message coupler network controller 23 includes, or has access to, sufficient processing capability to analyze the content of a customer's purchase as communicated by message coupler 20, and to correlate an item or items purchased (or other aspects of the purchase) with one or more consumer specific marketing messages to be provided. Message coupler network controller 23 then directs message coupler 20 to print the desired consumer specific marketing message or messages on ECR printer 15. Message coupler network controller 23 can also correlate and store data derived from a specific customer purchase, which can be used in additional marketing analysis.

A consumer specific marketing message can be printed in response to the purchase of one or more preselected items or groups of items. A loyalty promotion that provides a coupon for a store product or program, that thanks a customer, that awards points in a loyalty promotion program, or the like can be printed in response to the purchase of one or more products or groups of products. Purchase of one product may result in the printing of a consumer specific marketing message for either that or a competing product. The purchase of several products can result in printing a consumer specific message relating to a product that might be used with one or more of the group of products, is a competitor for one of more of the competing products, is a product that would provide a new use for the group of competing products, that is a line extension of one or more of the products, or the like. Such a marketing message can be, for example, either a coupon, an advertisement, or the like. A consumer specific marketing message can be printed as or include a bar code. For example, a bar code on a receipt can expedite return or exchange of an item purchased in a transaction and/or listed on the receipt. In addition, a bar code can be employed to track rewards or points in a loyalty promotion. The amount spent can either trigger or suppress one or more marketing messages. For example, the combination of particular purchase and a minimum amount spent can be necessary for printing a valuable inducement.

Preferably, a consumer specific marketing message is printed on a receipt by receipt printer 16 so that it is more readily viewed by the customer. A consumer specific marketing message can be printed on a slip by slip printer 17, which also places the message where it is readily viewed by the customer. In certain circumstances, such as for recording results of a loyalty promotion, it can be advantageous to employ journal printer 18 to print a consumer specific marketing message on a journal kept by the ECR to record its various transactions.

Hardware and Software Overview

Electronic cash register 1, store controller 5, and electronic cash register network 4 are conventional for point of sale systems. Various manufacturers supply each of these components and the invention is not limited to any particular manufacturer or configuration.

For example, the invention can be implemented using electronic cash registers 1 and store controllers 5 provided by International Business Machines (IBM) as point of sale systems, such as the 4680, for example the, 4683, 4684, the 4690 family, for example the 4692, 4693, 4694, and like systems; by National Cash Register (NCR) as the NCR 7050 and 7450 families, as the 1255, 2126, 2127, 2154, 2170 systems, and the like; by Data Checker as ICL, ISS45, or the like; for PC based point of sale registers, and the like.

Manufacturers of electronic cash registers and store controllers provide a software operating system for use in controlling operations of their, or other, hardware. Each of these operating systems is suitable for use with the system and method of the present invention. Additional operating systems and software that can be employed in the present system and method include DOS, FLEX O/S, NT, WINDOWS, UNIX and the like. An ECR processor 2 typically communicates with ECR printer 15 employing a protocol such as ESC-POS, IBM SIO, NCR LCSIO, USB, a proprietary protocol, or the like.

ECR printer 15 can be any of the following: a thermal printer, a dot matrix printer, a laser printer, an inkjet printer, or the like. Preferably ECR printer 15 is a thermal printer. Suitable printers include IBM Models 2, 3, 4, 4610, and the like; NCR 750 and the like; Axiohm 7156 and the like; Epson TMH 5000 and the like; and the like. Preferred thermal printers include the IBM Model 4610, the Axiohm 7156, the Epson TMH 5000, and the like. The ECR printer employed in the system or method of the invention can be the printer supplied by the ECR vendor as a dedicated ECR printer. Alternatively, the ECR printer can be supplied as a part of the system of the invention or for carrying out the method of the invention. In such circumstances, the ECR printer supplied for the system or method of the invention replaces the previous ECR printer.

Promotional Message Creation

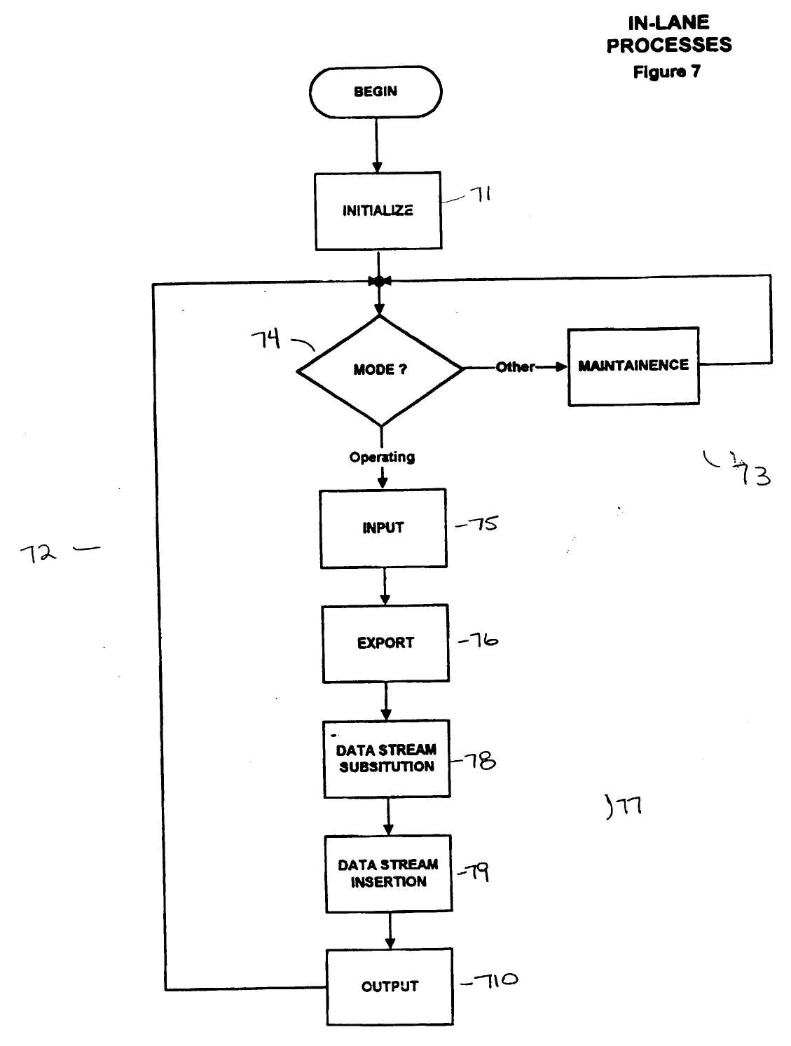

FIGS. 7-15 illustrate flowcharts of in-lane processes for systems and methods of an embodiment of the present invention. That is, these flowcharts describe a system and method for printing a marketing message on a receipt in response to issuance of a receipt. FIG. 7 provides an overview of these in-lane processes, and the subsequent figures provide additional details of the procedures and components of FIG. 7.

As shown in FIG. 7, the present invention can include initializing 71 ECR 1 and/or message coupler 20 making them ready for use, for example, at the start of a business day, at the opening of a particular customer service lane or station, or the like. After initialization 71, the system and process of the invention can cycle through numerous operating 72 and/or maintenance 73 routines without the need for additional initialization 71.

After initialization 71, and at the beginning of each routine, the present method and system can determine 74 if it should perform a maintenance 73 function or enter its operating 72 mode. If there is maintenance 73 to be performed, the system can query whether it can operate without the maintenance 73 or whether performing maintenance 73 at that time would hinder an ongoing operation of ECR 1. When the system can operate without maintenance 73, and/or if carrying out maintenance 73 would hinder an ongoing operation, maintenance 73 can be delayed. Alternatively, the system can carry out the desired maintenance 73. Then, the system can again query 74 whether there are other operations to carry out.

If so, the system enters operating 72 mode. First, the system waits for and/or receives input 75 from ECR 1. Then, if desired or required, the system can export 76 some or all of the input information to message coupler network 22. Employing information provided by message coupler network 22 or by message coupler 20, the system can, if desired, modify the data stream 77 by making one or more substitutions 78 into the data stream, making one or more insertions 79 into the data stream, or both. The modified data stream can then be output 710 to the output device, preferably, ECR printer 15. The system can then initiate another cycle.

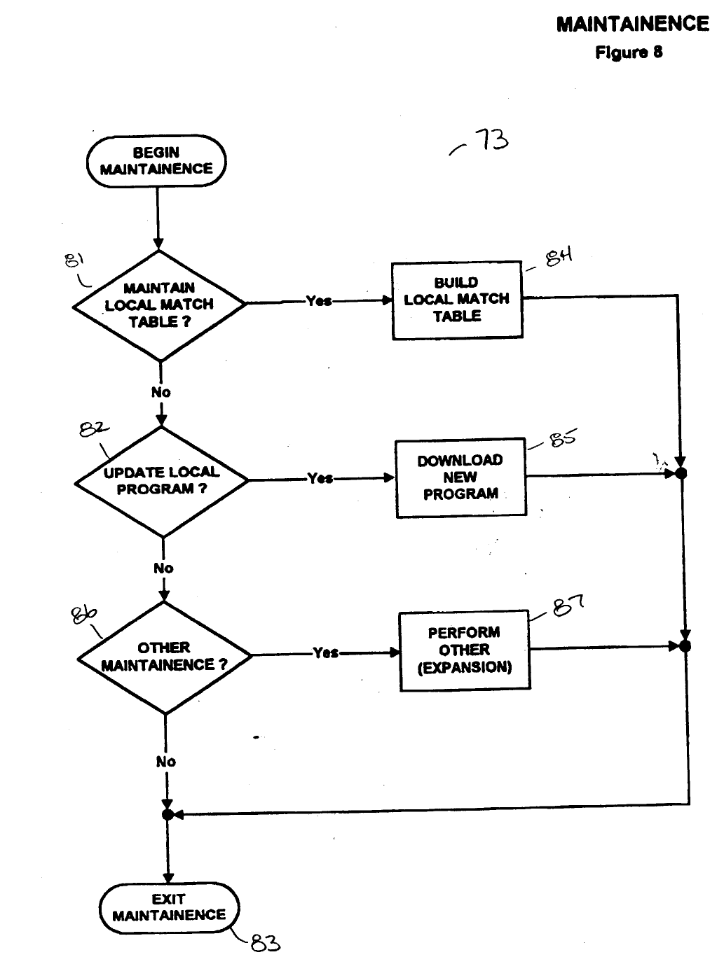

As shown in FIG. 8, maintenance 73 can include one or more of several maintenance routines. The system can accommodate maintenance functions such as maintaining a local match table 81 or updating a local program 82. The system and method can also optionally determine whether to carry out other maintenance 86 and perform that other maintenance 87. Such maintenance can include network quality testing, internal self testing, performing remote monitoring functions, accounting reports and the like. When maintenance is complete, the system exits the maintenance routine 83.

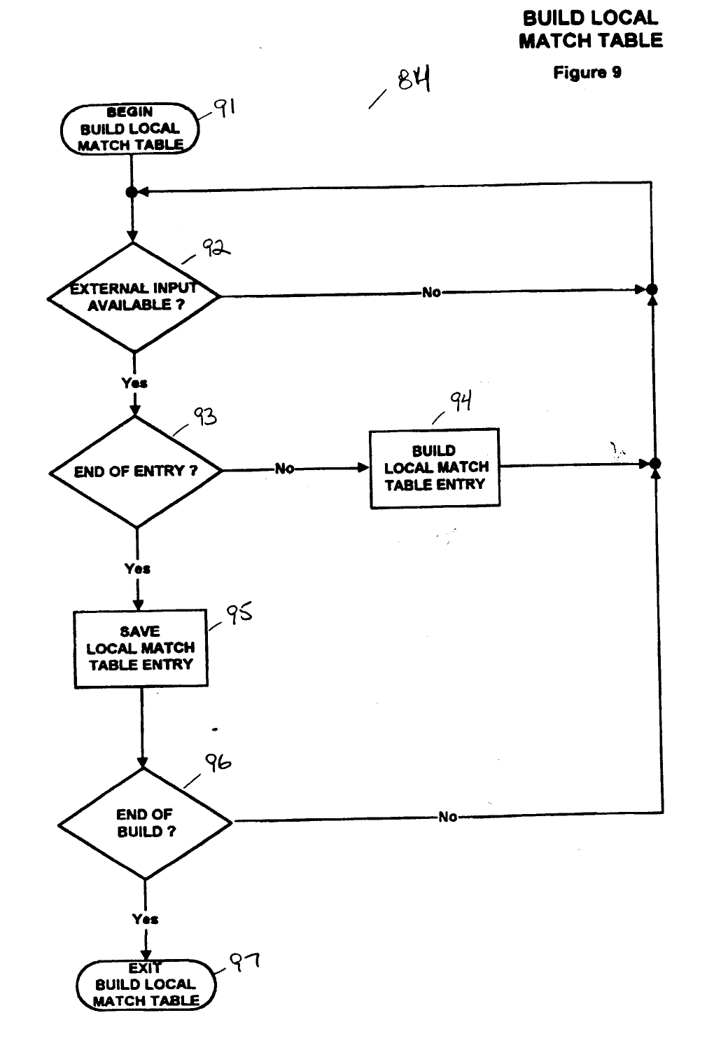

As shown in FIGS. 8 and 9, for example, maintenance can include maintaining and/or building a local match table 81. The local match table includes a list, an array, a matrix, a database, or the like of those input strings that, when they appear as input, cause message coupler 20 to respond, and also indicate the response. Message coupler 20 can respond by, for example, exporting 76 some or all of the input 75 information to message coupler network 22, making one or more substitutions 78 into the data stream, making one or more insertions 79 into the data stream, or the like.

Building the local match table 84 can occur by standard methods for creating or communicating match tables and like lists, matrices, arrays, or databases. For example, FIG. 9 illustrates beginning building 91 a local match table by determining if any external input is available 92. If not, the system can wait for external input. If external input is available, the system queries whether the end of the particular input entry has been reached 93. If not, this entry is employed to build the local match table 94. If the system has reached the end of the entry, the entry is saved to the local match table 95. After saving the entry, the system decides whether the entire match table has been built 96. If not, the system returns to find or await additional external input. If the system has built the match table, the system exits the build local match table 97 routine.

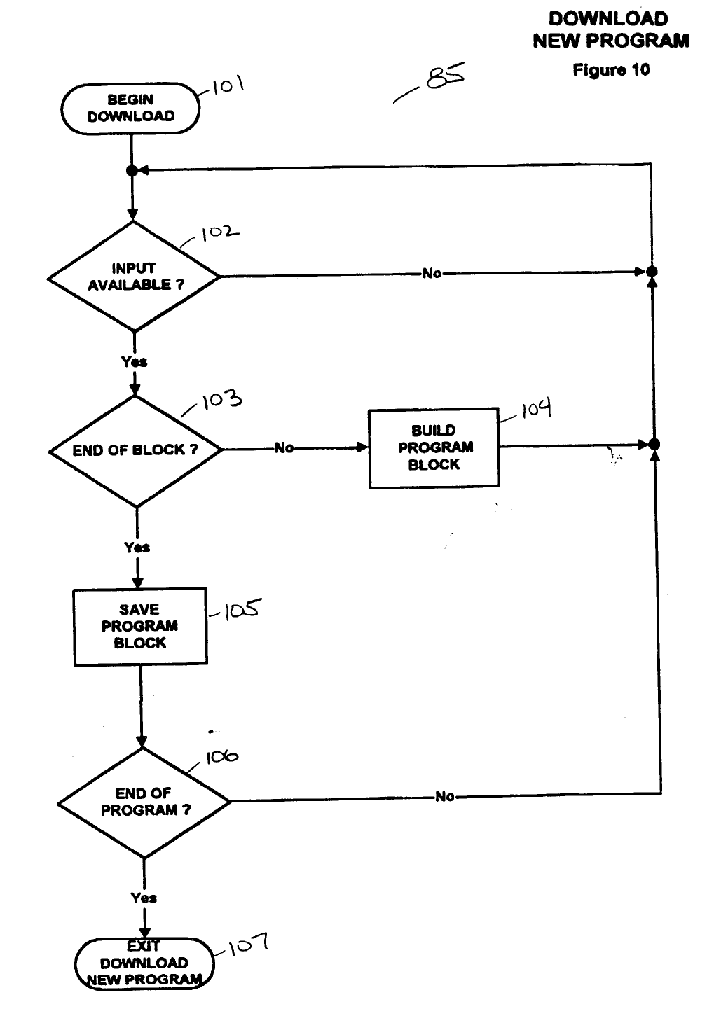

As shown in FIGS. 8 and 10, maintenance can also include updating the local program 82 in message coupler 20 by downloading a new program 85. The local program can control message coupler 20 and each of the functions or processes carried out by message coupler 20. For example, the local program can modify or build the local match table, can control export of some or all of the input information to message coupler network 22, can control receipt of information from message coupler network 22, can make one or more substitutions into the data stream, can make one or more insertions into the data stream, can perform testing and maintenance functions, can conduct account reporting, can carryout functions described in FIGS. 7-18, or the like.

Downloading the local program can be conducted by standard methods for downloading, creating, or communicating programs from one device, system, or network to another. For example, FIG. 10 illustrates beginning downloading 101 a new program by determining if any external input is available 102. If not, the system can wait for external input. If external input is available, the system decides whether the end of the particular input block 103 has been reached. If not, this input block is employed to build a program block 104. If the system has reached the end of the block, the block is saved to the local program 105. After saving the block, the system decides whether the end of the program has been reached 106. If not, the system returns to find or await additional external input. If the system has downloaded the entire program, the system exits the download program routine 107.

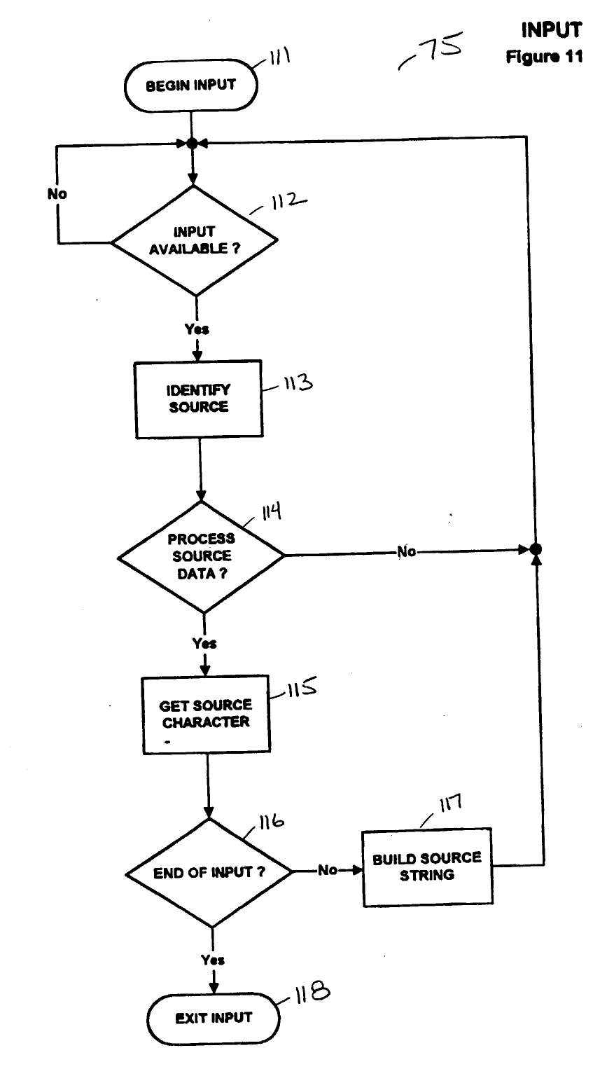

Input into the message coupler system can include typical procedures known in the art for input of information into a processing system. Various input peripherals 3 of ECR 1 provide input. These peripherals 3 include keyboard 11, scanner 13, and the like. FIG. 11 illustrates, for example, beginning input 111 by deciding whether input is available 112. If not, the system waits for input. If input is available, the system identifies the source 113 of the input. The system then decides whether to process this input data from this source 114. If not, the system returns to await input. If the system decides to process this data, the system gets the source character 115 for this data. The system then decides whether this source character is the end of the input 116. If not, the system employs this source character to build a source string 117. If this source character is the end of the input, the system exits the input 118 routine. That is, when the system decides that the item is ready and/or the source string is complete, the system can exit the input 118 routine.

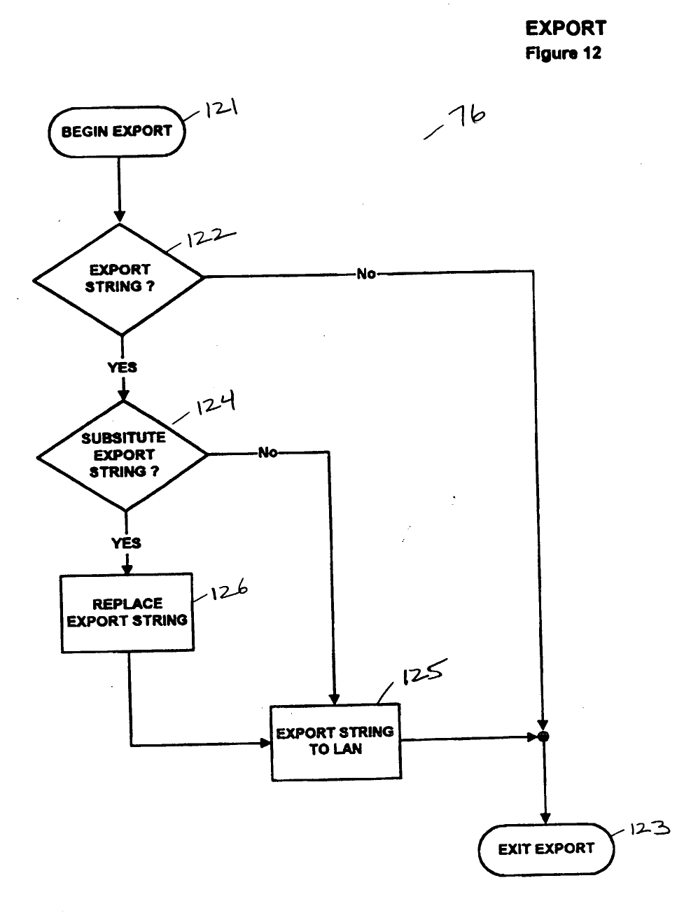

Export of a string or other information from message coupler 20 can be accomplished by any of a variety of methods or protocols known in the art for such export. For example, FIG. 12 illustrates beginning export 121 by deciding whether to export a string 122, such as a source, a modified, or a substitute string. If no string is to be exported, the system exits the export subroutine. If a string is to be exported, the system decides whether to substitute 124 a substitute string for the original source string. Substitution of the string can modify the length of the string, modify the content of the string, modify the string to enhance processing at network controller 23, and the like. If the system decides not to substitute, the original source string is exported 125 to message coupler network 22. If the system is to export a substitute string, the system replaces original string 126 with the substitute string, which is exported to 125 message coupler network 122. After exporting the substitute string, the system exits the export 123 routine.

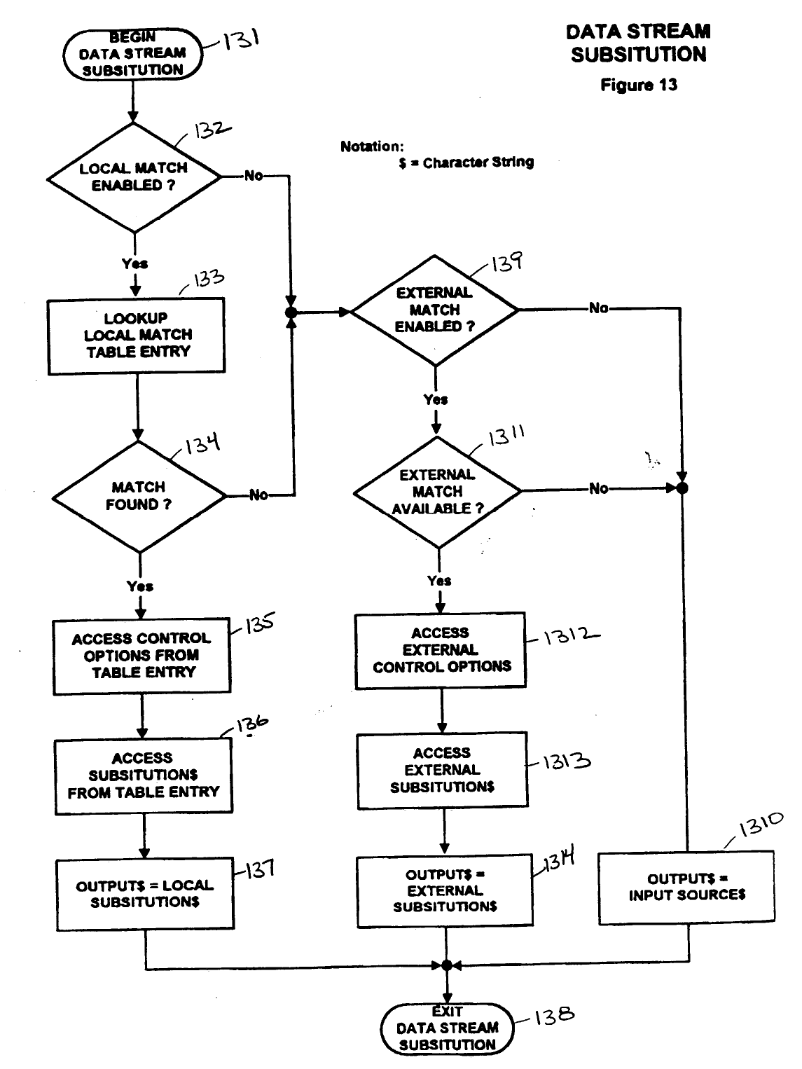

Either message coupler 20 or message coupler network controller 23 can carry out data stream substitution by any of the protocols that are common in the art for data stream substitution. For example, FIG. 13 illustrates beginning data stream substitution 131 by determining whether local match is enabled 132. If so, the system looks up the local match table entry 133. If a match is found 134, the system accesses control options from the table entry 135, if any, accesses substitutions from the match table entry 136, and sets the output string equal to the value indicated by the table entry 137. The system then exits the data stream substitution routine 138. FIG. 13 illustrates that two conditions lead to determining whether external match is enabled 139. If local match is not enabled, or if a local match is not found, the system determines whether external match is enabled 139. If not, the system sets the output string equal to the input source string 1310 and exits the data stream substitution 138 routine and the input source string is passed through this routine. If external match is enabled, the system determines whether an external match is available 1311. If external match is unavailable (as described below), the system sets the output string equal to the input source string 1310 and exits the data stream substitution routine. Again, the input source string is passed through. If an external match is available, the system accesses external control options 1312, if any, accesses an external substitution string 1313, and sets the output string equal to the external substitution string 1314. If neither a local nor an external match is indicated, the data substitution routine passes through the input source string. Then, the system exits the data substitution 138 routine.

Any of a variety of conditions can result in the unavailability of external match. External match can be unavailable, for example, if external match would unacceptably delay processing the transaction. A delay can result, for example, if message coupler network 22 is down, occupied with a task that consumes enough of its capacity to delay communication with an individual message coupler 20, is unable to deliver data, or the like. The length of an unacceptable delay can vary depending on its position in the transaction. At the end of a transaction an acceptable delay does not unacceptably delay concluding the transaction or cause the customer an unacceptable wait. In the midst of a transaction, such as between or while scanning individual items, an acceptable delay does not unacceptably hinder the operator from scanning or entering additional input.

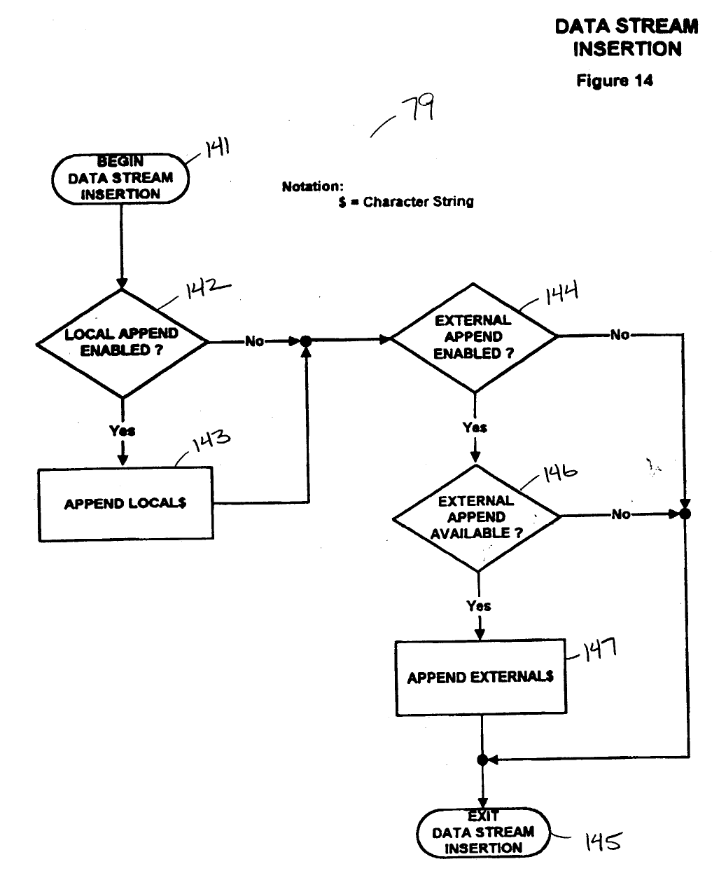

Either message coupler 20 or message coupler network controller 23 can carry out data stream insertion 79 by any of the protocols that are common in the art for data stream insertion. For example, FIG. 14 illustrates beginning data stream insertion 141 by determining whether local append is enabled 142. If so, the system appends the local append string 143. If local string append is not enabled or after appending the local append string, the system determines whether external append is enabled 144. If not, the system exits the data stream insertion 145 routine and the input source string is passed through this routine. If external append is enabled, the system determines whether external append is available 146. If external append is unavailable (as described below), the system exits the data stream insertion 145 routine and the input source string is passed through this routine. If external append is available, the system appends the external string 147. If neither a local nor an external append is indicated, the data insertion routine passes through the input source string. The system then exits the data stream insertion routine.

Any of a variety of conditions can result in unavailability of external append. External append can be unavailable, for example, if external append would unacceptably delay processing the transaction. A delay can result, for example, if message coupler network 22 is down, occupied with a task that consumes enough of its capacity to delay communication with an individual message coupler 20, is unable to deliver data, and the like. The length of an unacceptable delay can vary depending on its position in the transaction. At the end of a transaction an acceptable delay does not unacceptably delay concluding the transaction or cause the customer an unacceptable wait. In the midst of a transaction, such as between or while scanning individual items an acceptable delay does not unacceptably hinder the operator from scanning or entering additional input.

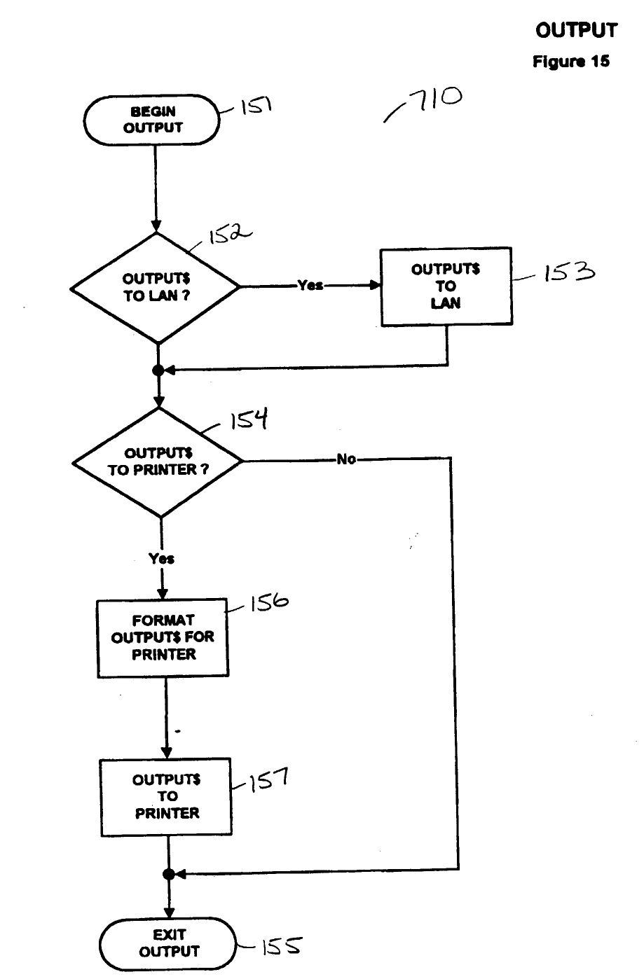

Message coupler 20 can send output to message coupler network 22 or to an ECR peripheral 3, preferably to ECR printer 15, using any of a variety of output formats and protocols known to those of skill in the art. For example, FIG. 15 illustrates beginning output 151 by determining whether the output string should be output to 152 message coupler network 22. If so, the output string is output to 153 message coupler network 22. A string sent to message coupler network 22 can be stored or processed by any of a variety of systems and programs known in the art for processing output strings. Typical uses for an output string from a message coupler 22 include verification and tally of the transaction and/or of printing of a consumer specific marketing message. After the output string is output to message coupler network 22, or if the output string is not to be output to this network, the system determines whether the output string should be output 154 to ECR printer 15. If not, system exits the output 155 routine. If the output string is to be output to ECR printer 15, the system formats the output string 156 for ECR printer 15 and outputs the output string to 157 ECR printer 15. Then, the system exits the output 155 routine, and returns to determining the mode 74 for the system near the beginning of the in lane processes routine of FIG. 7.

It will be apparent to those of skill in the art that certain of the routines illustrated in FIGS. 7-15 include processes or blocks that can occur in different sequences than those illustrated, or that can occur simultaneously or in parallel. The present invention includes such different sequences, such simultaneity, such parallel activity, and the like.

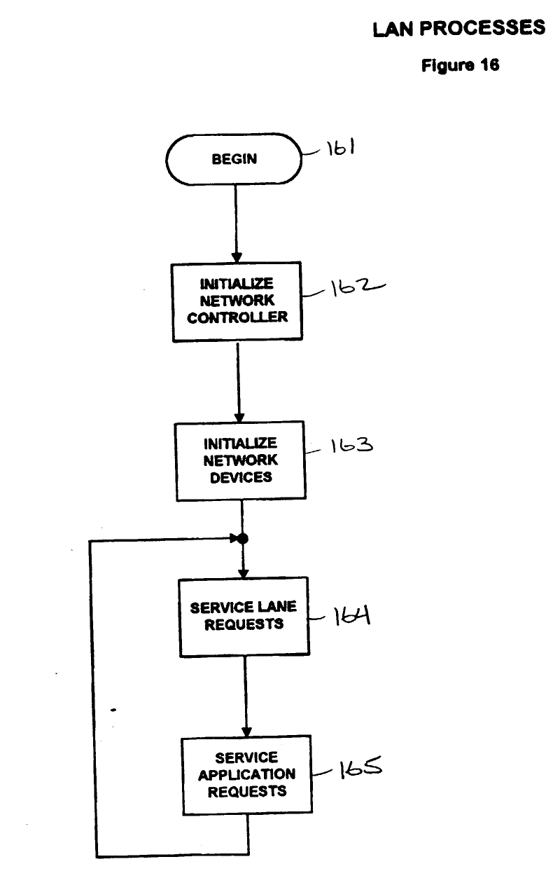

FIG. 16 illustrates an example of a process employing message coupler network 22. This illustrative process begins 161 with initialization of the network controller 162, for example, message coupler network controller 23. Then, the system initializes network devices 163, such as one or more message couplers 20, and the like. Following initialization, the system can service lane requests 164 and service application requests 165. The system can then repeatedly, in either order, continue to service lane requests and service application requests.

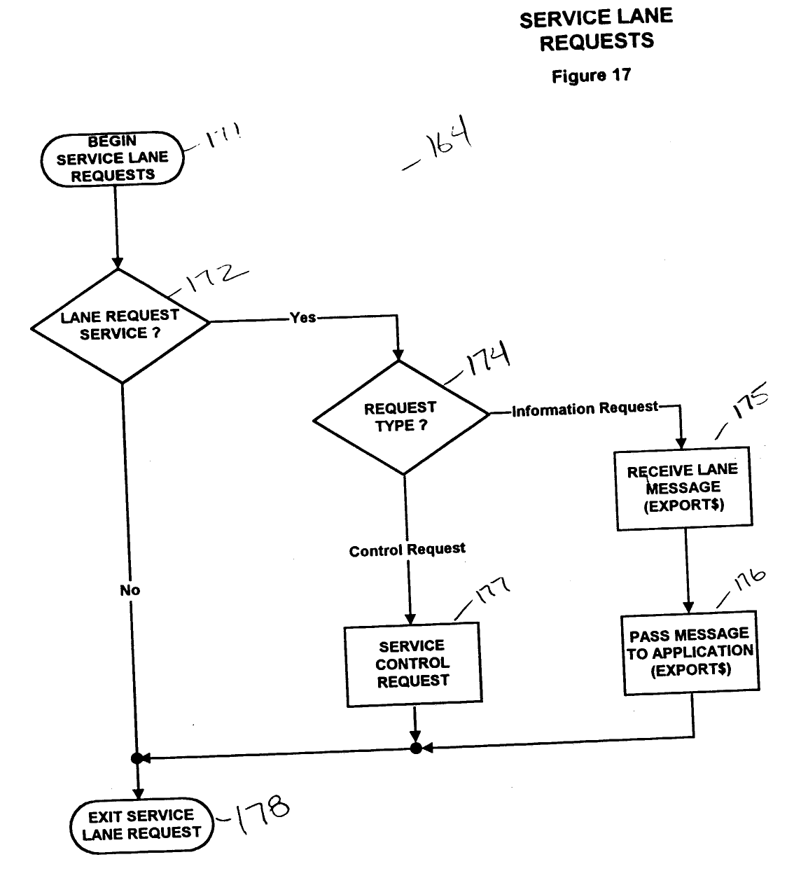

Message coupler network 22 can service lane requests 164 by any of a variety of known protocols and processes through which a network and its controller can service requests from associated processors and devices. For example, FIG. 17 illustrates beginning servicing a lane request 171 by determining whether such service has been requested by the lane polled 172. If that lane does not have a service request, message coupler network controller 23 can exit service lane request 178 routine. If a lane has a service request, message coupler network controller 23 can determine the type of request 174. If the request is an information request, message coupler network controller 23 can receive the lane message 175, typically an export string, and pass that lane message on to an application 176. The application can be an electronic journaling application, a data analysis application, a data storage application, a remote data processing application, an internet application, and the like. If the request is a control request, message coupler network controller 23 services the control request 177. For example, message coupler network controller 23 can service maintenance requests, facilitate addition or deletion of a message coupler 20 into operation on the network, and the like. After message coupler network controller 23 services the control request 177 and/or passes that lane message on to an application 176, message coupler network 22 can exit the service lane request 178 routine.

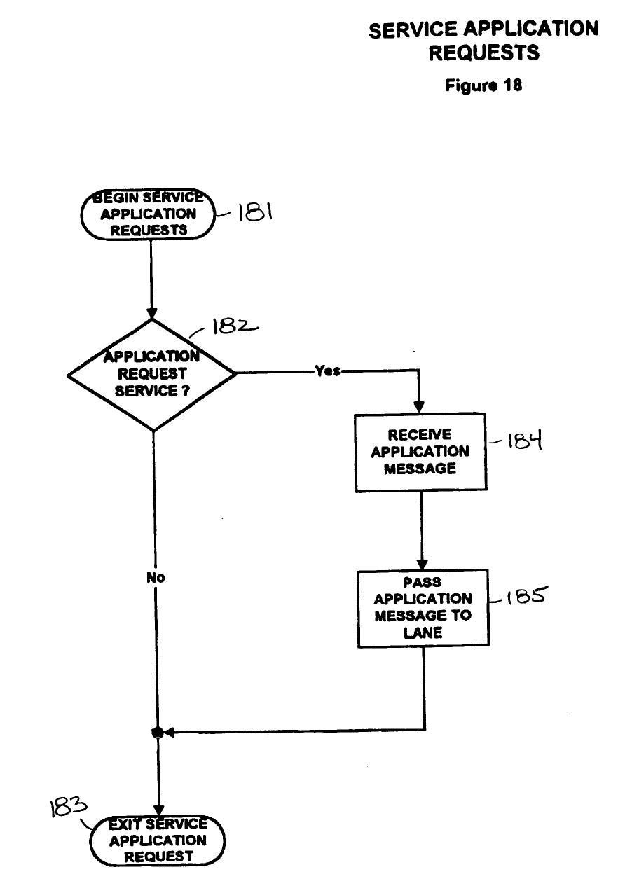

Message coupler network controller 23 can service application requests by any of a variety of protocols and procedures known in the art by which one system or controller can service an application request from another system or device. For example, FIG. 18 illustrates beginning servicing application requests 181 by determining whether an application service request exists 182. If not, message coupler network controller 23 exits the service application request 183 routine. If there is an application service request to service, the system can receive the application message 184, and pass the application message to one or more lanes 185 that can act on this request. Then, message coupler network 22 can exit the service application request routine.

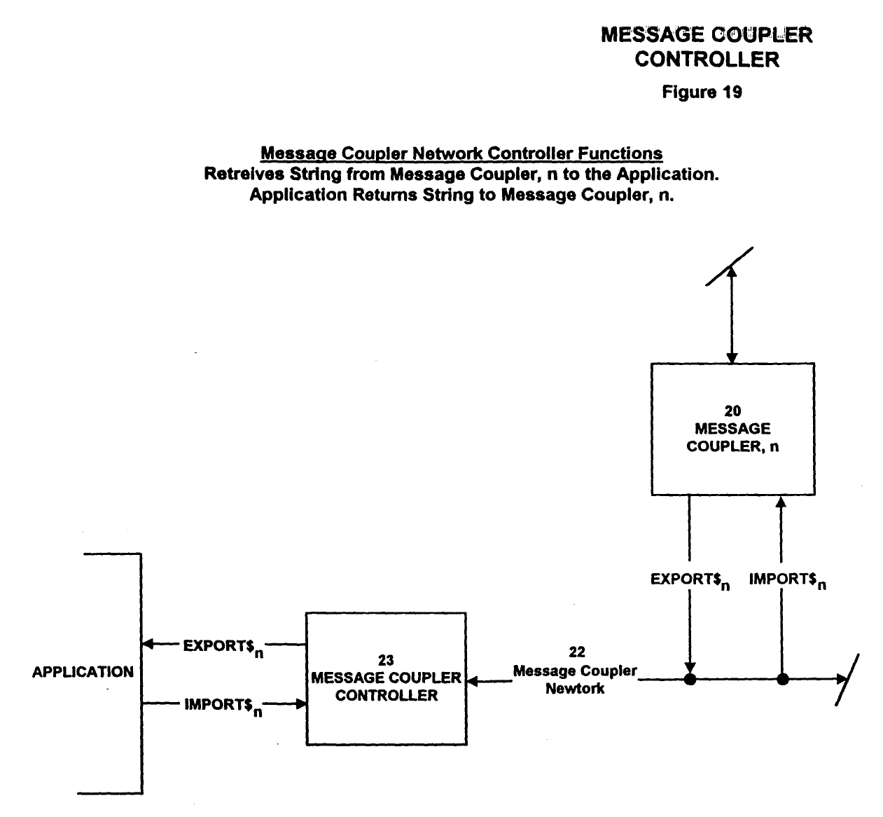

Certain portions of the in lane processes and certain preparations for carrying out the in lane processes employ message coupler network 22. Such various export, import, and service processes can be carried out with any of a components in a system of the present invention. FIG. 19 illustrates one such arrangement of a system of the present invention. This illustration presents a simplified block diagram of a plurality of message couplers 20 coupled to an application by employing message coupler network 22. Such an arrangement can retrieve a string from a message coupler 20 to the application, and the application can return a string to message coupler 20.

It will be apparent to those of skill in the art that certain of the routines illustrated in FIGS. 16-19 include processes or blocks that can occur in different sequences than those illustrated, or that can occur simultaneously or in parallel. The present invention includes such different sequences, such simultaneity, such parallel activity, and the like.

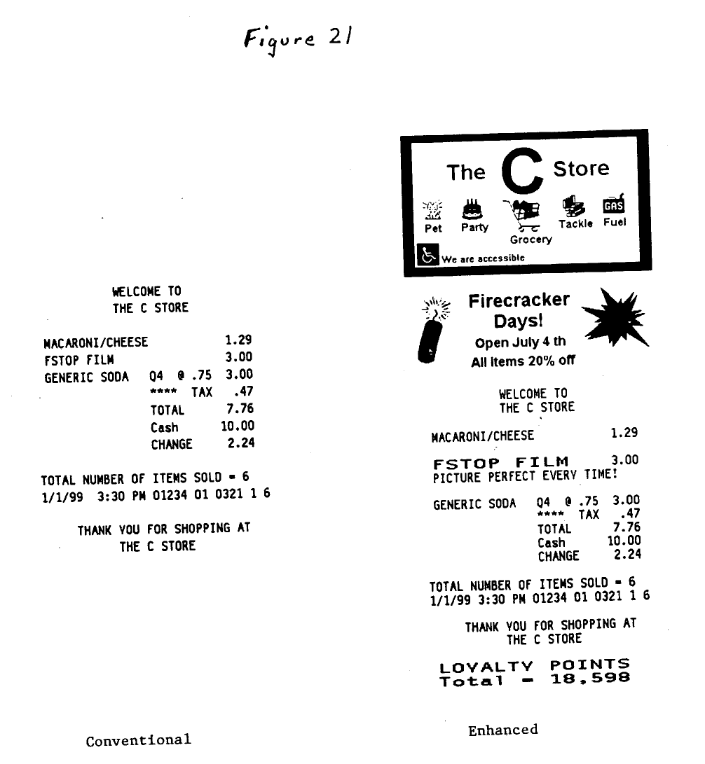

FIG. 21 illustrates a conventional store receipt and an enhanced receipt including marketing messages. The enhanced receipt was produced according to an embodiment of the system and method of the present invention. The conventional receipt includes only plain text identifying the store, listing the items sold, and thanking the customer. The enhanced receipt produced according to an embodiment of the present invention includes several marketing messages. This enhanced receipt begins with a graphic including a store logo and advertising the variety of products sold at “The C Store”. After the store logo and ad, the system added a seasonal message including a graphic and details of upcoming discounts at the store during “Firecracker Days”. Such a seasonal message could be either a standard message on each receipt, or could be targeted to specific customers, for example members of a loyalty program or purchasers of a particular product. Amid the list of items purchased, the entry for “FSTOP FILM” has been enlarged and made bold to call the customer's attention to this brand name. This is a consumer specific marketing message, the message is printed in response to a customer purchase. The entry for “FSTOP FILM” also includes an added slogan reminding the customer that “FSTOP FILM” produces a “PERFECT PICTURE EVERY TIME!”. The bottom of the enhanced receipt includes a consumer specific message informing the customer that he or she has accumulated, as of that purchase, a total of 18,598 loyalty points.

In the present application a device that can perform a particular activity can be described as “adapted and configured” to perform that activity. Adapted and configured can also be phrased as “arranged and configured”, “adapted”, “constructed and arranged”, “constructed”, and using like terms and phrases.

The present invention is applicable to numerous different message coupler systems and methods employing them. Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art upon review of the present specification. The claims are intended to cover such modifications and devices.

We claim:

1. A system for modifying communication between an electronic cash register and an ECR printer comprising:
a message coupler adapted and configured to receive communication between the electronic cash register and the ECR printer, and to modify a data stream being communicated from the electronic cash register to the ECR printer;
modifying the data stream comprising appending data to the data stream, inserting data into the data stream, substituting into the data stream, or a combination thereof.

2. The system of claim 1, wherein the ECR printer comprises a receipt printer, a journal printer, a slip printer, or a combination thereof.

3. The system of claim 1, wherein the message coupler is adapted and configured to provide to the ECR printer a consumer specific marketing message for printing on a receipt, on a slip, or a combination thereof.

4. The system of claim 3, wherein the message coupler comprises a processor and memory adapted and configured for storing at least one consumer specific marketing message and providing the consumer specific marketing message to the ECR printer in response to the purchase of one or more preselected products.

5. The system of claim 3, wherein the message coupler comprises a processor and memory adapted and configured for identifying a preselected product, associating the purchase of the preselected product with the consumer specific marketing message, and directing the ECR printer to print the consumer specific marketing message on the receipt.

6. The system of claim 4 or 5, wherein the consumer specific marketing message comprises a seasonal message.

7. The system of claim 4 or 5, wherein the consumer specific marketing message comprises a bold type message, a graphic, or a slogan, printed amid a list of items on the receipt.

8. The system of claim 4 or 5, wherein the consumer specific marketing message comprises a message after a list of items on the receipt.

9. The system of claim 1, wherein the message coupler is adapted and configured to perform a preselected modification on each data stream.

10. The system of claim 1, wherein the message coupler is adapted and configured to modify the data stream in response to a single data string in the data stream.

11. The system of claim 1, wherein the message coupler is adapted and configured to modify the data stream in response to a plurality of data strings in the data stream.

12. The system of claim 11, wherein the message coupler is adapted and configured to make a single modification to the data stream in response to a plurality of data strings in the data stream.

13. The system of claim 11, wherein the message coupler is adapted and configured to make a plurality of modifications to the data stream in response to a plurality of data strings in the data stream.

14. The system of claim 1, further comprising a message coupler network and a message coupler network controller, the message coupler and message coupler network controller being adapted and configured to communicate through the message coupler network.

15. The system of claim 14, wherein the message coupler network controller is adapted and configured to modify the data stream by appending data to the data stream, by inserting data into the data stream, by substituting into the data stream, or a combination thereof.

16. The system of claim 14, wherein the message coupler network controller is adapted and configured to provide to the ECR printer a consumer specific marketing message for printing on a receipt, on a slip, or a combination thereof.

17. The system of claim 14, wherein the message coupler network controller is adapted and configured to modify the data stream in response to a single data string in the data stream.

18. The system of claim 14, wherein the message coupler network controller is adapted and configured to modify the data stream in response to a plurality of data strings in the data stream.

19. The system of claim 18, wherein the message coupler network controller is adapted and configured to make a single modification to the data stream in response to a plurality of data strings in the data stream.

20. The system of claim 18, wherein the message coupler network controller is adapted and configured to make a plurality of modifications to the data stream in response to a plurality of data strings in the data stream.

21. The system of claim 14, wherein the message coupler network controller is adapted and configured to control and maintain the message coupler network and the message coupler.

22. The system of claim 14, wherein the system is adapted and configured for communicating between the message coupler controller and an external system.

23. The system of claim 22, wherein the system is adapted and configured for communicating a consumer specific marketing message from the external system to the message coupler.

24. The system of claim 22, wherein the system is adapted and configured for exporting data from a customer transaction to the external system.

25. The system of claim 22, wherein the external system comprises an internet.

26. The system of claim 14, comprising a plurality of message couplers.

27. The system of claim 1, further comprising the electronic cash register and the ECR printer, the electronic cash register comprising an input peripheral for entry of a product code of an item in a customer transaction, the ECR printer being adapted and configured for printing in response to input from the electronic cash register or the message coupler.

28. The system of claim 27, further comprising a plurality of electronic cash registers.

29. The system of claim 27, further comprising a plurality of message couplers.

30. The system of claim 27, further comprising a message coupler network and a message coupler network controller, the message coupler and message coupler network controller being adapted and configured to communicate through the message coupler network.

31. The system of claim 30, wherein the message coupler network controller is adapted and configured to provide to the ECR printer a consumer specific marketing message for printing on a receipt, on a slip, or a combination thereof.

32. A system for printing a consumer specific marketing message on a customer receipt in response to a customer transaction, the system comprising:
an electronic cash register, the electronic cash register comprising an input peripheral for entry of a product code of an item of a customer transaction;
an ECR printer;
a message coupler; the message coupler being adapted and configured to receive communication between the electronic cash register and the ECR printer, and to provide to the ECR printer a consumer specific marketing message for printing on a customer receipt.

33. The system of claim 32, wherein the message coupler provides a standard message to each receipt.

34. The system of claim 32, wherein the message coupler provides a consumer specific marketing message in response to a purchase of a single preselected item.

35. The system of claim 32, wherein the message coupler provides a consumer specific marketing message in response to a purchase of a plurality of preselected items.

36. The system of claim 32, wherein the message coupler provides a plurality of consumer specific marketing messages in response to a purchase of a plurality of preselected items.

37. The system of claim 32, further comprising a message coupler network and a message coupler network controller; the message coupler network and message coupler controller network being adapted and configured to communicate with the message coupler.

38. The system of claim 37, wherein the message coupler network controller is adapted and configured to provide to the ECR printer a consumer specific marketing message for printing on a receipt, on a slip, or a combination thereof.

39. A method for printing a consumer specific marketing message on a customer receipt in response to a customer purchase, the method comprising:
preselecting one or more products, the purchase of which results in printing one or more consumer specific marketing messages;
preselecting one or more marketing messages for printing in response to purchase of one or more preselected products;
identifying a preselected product in a customer transaction;
associating the identified product with the marketing message; and
printing on the receipt one or more consumer specific marketing messages.

40. The method of claim 39, further comprising locally storing least one consumer specific marketing message and locally providing the consumer specific marketing message to the ECR printer in response to the purchase of one or more preselected products.

41. The method of claim 40, further comprising employing a message coupler for locally storing locally providing, or a combination thereof.

42. The method of claim 39, further comprising locally identifying the preselected product, locally associating the purchase of the preselected product with the consumer specific marketing message, and locally directing the ECR printer to print the consumer specific marketing message on the receipt.

43. The method of claim 42, further comprising employing a message coupler for locally identifying, locally associating, locally directing, or a combination thereof.

44. The method of claim 39, wherein printing comprises printing amid a list of items purchased on the receipt, printing after a list of items purchased on the receipt, or a combination thereof.

45. The method of claim 39, wherein associating occurs in response to purchasing a single preselected product, in response to purchasing a plurality of preselected products, or a combination thereof.

46. The method of claim 39, further comprising communicating with a message coupler network.

47. The method of claim 46, further comprising communicating a consumer specific marketing message from a message coupler network to a message coupler.

48. The method of claim 46, further comprising controlling printing from a message coupler network controller.

49. The method of claim 46, wherein controlling comprises communication between the message coupler network and a message coupler.

50. The method of claim 46, wherein communicating comprises communicating between the message coupler network and an external system.

51. The method of claim 50, wherein communicating comprises communicating a consumer specific marketing message from the external system to the message coupler.

52. The method of claim 50, wherein communicating comprises providing data from a customer transaction to the external system.

53. The method of claim 50, wherein communicating comprises communicating with an internet.

54. The method of claim 46, wherein communicating comprises providing data from a customer transaction to the message coupler network.

55. The method of claim 39, wherein associating comprises data stream substitution.

56. The method of claim 39, wherein associating comprises data stream insertion.
